(19) United States
(12) Patent Application Publication
(10) Pub. No.: US 2021/0229814 A1
(43) Pub. Date: Jul. 29, 2021

(54) OCCUPANT RESTRAINT SYSTEMS FOR USE ON AIRCRAFT

(71) Applicant: AmSafe, Inc., Phoenix, AZ (US)

(72) Inventors: Michael Shawn Haycraft, Gilbert, AZ (US); Bradley Scott Walker, Gilbert, AZ (US)

(21) Appl. No.: 16/773,854

(22) Filed: Jan. 27, 2020

(51) Int. Cl. B64D 11/06

(52) U.S. Cl. CPC B64D 11/0621; B64D 11/0647

(57) ABSTRACT

Occupant restraint systems for use in aircraft and other vehicles are described herein. In some embodiments, the occupant restraint systems include an under-seat airbag positioned below a seat cushion having a separation feature extending laterally therethrough. The separation feature enables a front cushion portion to move upwardly and away from a seat pan by a greater distance than a rear cushion portion upon inflation of the under-seat airbag, thereby favorably positioning the seat occupant's thighs relative to the seat occupant's torso.

### TECHNICAL FIELD

The following disclosure relates generally to occupant restraint systems for use in aircraft and other vehicles and, more particularly, to occupant restraint systems having airbags.

### BACKGROUND

Airbags can protect occupants from strike hazards in automobiles, aircraft, and other vehicles. In conventional airbag systems, a sensor detects a collision or other dynamic event of sufficient magnitude and transmits a corresponding signal to an initiation device (e.g., a pyrotechnic device) on an inflator. The signal causes the inflator to release compressed gas into the airbag, rapidly inflating the airbag in front of the occupant to cushion the occupant's impact with forward objects.

Forward head excursion during a crash event can limit how close airlines can position one row of passenger seats to another, and how close passenger seats can be positioned relative to a partition wall or other potential strike hazard. Accordingly, it is generally desirable to reduce forward head excursion so that passenger seats can be placed closer to potential strike hazards, while still maintaining enough distance to ensure that occupants do not contact the strike hazards during a crash event.

### BRIEF DESCRIPTION OF THE DRAWINGS

FIG. 1 is a front isometric view of an occupant seated in an aircraft seat having a seat cushion and an under-seat airbag configured in accordance with embodiments of the present technology.

FIG. 2 is a partially schematic isometric view of an aircraft airbag system and an associated seat cushion configured in accordance with embodiments of the present technology.

FIGS. 3A and 3B are side and bottom views, respectively, of an aircraft seat cushion configured in accordance with embodiments of the present technology.

FIG. 4 is a top isometric view of an under-seat airbag configured in accordance with embodiments of the present technology.

FIGS. 5A and 5B are side views illustrating the airbag of FIG. 4 positioned under the seat cushion of FIGS. 3A and 3B with the airbag in pre-inflated and inflated states, respectively, in accordance with embodiments of the present technology.

FIGS. 6A-6C are a series of side views illustrating various stages of operation of an occupant restraint system having an under-seat airbag and seat cushion configured in accordance with embodiments of the present technology.

FIGS. 7A-7C are a series of side views illustrating various stages of operation of an occupant restraint system having a seat belt airbag, an under-seat airbag, and a seat cushion configured in accordance with embodiments of the present technology.

### DETAILED DESCRIPTION

The following disclosure describes various embodiments of occupant restraint systems that include an airbag positioned beneath a seat cushion having a separation feature extending laterally thereacross. The separation feature effectively separates the seat cushion into a front portion and a rear portion. Upon inflation, the airbag drives the front portion upwardly and away from a seat pan by a greater distance than the rear cushion portion. This causes upward momentum of the seat occupant's knees relative to the occupant's pelvic region, which can advantageously reduce a forward momentum of the seat occupant's torso in response to a dynamic crash event.

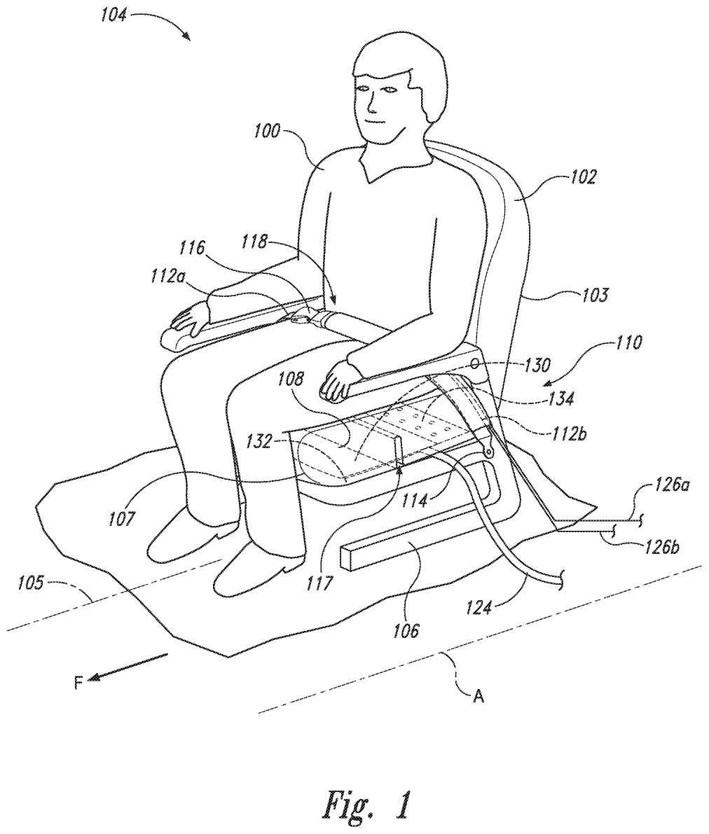

Certain details are set forth in the following description and in FIGS. 1A-7C to provide a thorough understanding of various embodiments of the present technology. In other instances, other details describing well-known structures, materials, methods and/or systems often associated with aircraft seats, seat cushions, airbags, airbag inflation systems and related circuitry, aircraft seating areas, seat belts, etc. in aircraft and other vehicles are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 102 is first introduced and discussed with reference to FIG. 1.

As used herein, the terms “rapid deceleration event”, “dynamic event”, “crash event,” and the like refer to events imparting a substantial force (e.g., a deceleration force) on the vehicle and/or occupants seated within the vehicle, including but not limited to a crash, a collision, a maneuver to avoid a crash, a maneuver to avoid a collision, etc. As used herein, the use of relative terminology, such as “about”, “approximately”, “generally” and the like refer to the stated value plus or minus ten percent unless otherwise specified. For example, the use of the term “about 100” refers to a range of from 90 to 110, inclusive. In instances where relative terminology is used in reference to something that does not include a numerical value, the terms are given their ordinary meaning to one skilled in the art.

FIG. 1 is a front isometric view of a seat occupant 100 (e.g., a passenger) secured in a seat 102 by an occupant restraint system 110 configured in accordance with embodiments of the present technology. In the illustrated embodiment, the seat 102 is positioned in an aircraft seating area 104, such as a passenger cabin of a commercial, private, or general aviation aircraft. The seat 102 includes a back portion 103 extending upwardly from a base portion 107 in a conventional manner. The base portion 107 can include a seat cushion 108 (e.g. a foam cushion) upon which the occupant 100 sits, and a seat pan 132 that supports the seat cushion 108. As described in detail below, the seat cushion 108 includes a separation feature 117.

In the illustrated embodiment, the seat 102 faces forward, or at least generally forward, in direction F toward a front of the aircraft. Accordingly, in this embodiment, a centerline 105 of the seat 102 extends parallel to, or at least approximately parallel to, a longitudinal axis A of the aircraft (e.g., a longitudinal axis of the aircraft fuselage). In other embodiments, the seat 102 can be positioned so that the occupant 100 faces generally forward, but with the seat centerline 105 orientated at an angle (e.g., an oblique angle) relative to the longitudinal axis A. For example, in such embodiments the seat centerline 105 can be positioned at angles from about 5 degrees to about 90 degrees, or from about 10 degrees to about 45 degrees, relative to the longitudinal axis A. In other embodiments, the seat can be positioned in other orientations and/or in other settings and arrangements. Additionally, as those of ordinary skill in the art will appreciate, although only one seat 102 is illustrated in FIG. 1, in some embodiments additional seats can be positioned to one or both sides of the seat 102 to create a row of seats, and/or in front of or behind the seat 102 in additional rows. In other embodiments, the seat 102 can be positioned behind a partition (e.g., a closet or galley wall), or other structure.

In the illustrated embodiment, the occupant restraint system 110 includes a lap seatbelt 118 (which can also be referred to as “two-point” restraint) having a first web portion 112a and a second web portion 112b. The web portions 112a, b can be at least generally similar in structure and function to conventional seatbelt webbing comprised of, for example, woven nylon, woven polyester, etc. A proximal end of the second web portion 112b is fixedly attached to a seat frame 106 on one side of the occupant 100 by an attachment fitting 114, and a proximal end of the first web portion 112a is similarly attached to the seat frame 106 on the opposite side of the occupant 100. A distal end of the first web portion 112a carries a buckle 116 that is configured to receive and releasably engage a corresponding web connector tongue (not shown in FIG. 1) attached to the distal end of the second web portion 112b. In operation, the occupant 100 secures the seatbelt 118 around his or her waist in a conventional manner. More specifically, after sitting in the seat 102, the occupant 100 can insert the connector tongue on the second web portion 112b into the buckle 116 and adjust the tension in the seatbelt 118 in a conventional manner, To release the seatbelt 118, the occupant 100 can lift a handle on the buckle 116 or otherwise releases the connector tongue from the buckle 116 in a conventional manner.

In the illustrated embodiment, the occupant restraint system 110 further includes an under-seat airbag 130. Prior to installation on the seat 102, the under-seat airbag 130 is folded and stowed within a flexible protective cover 134. In some embodiments, the covered under-seat airbag 130 is positioned on the seat pan 132 beneath the seat cushion 108, or beneath at least a portion of the seat cushion 108. In other embodiments, the under-seat airbag 130 can be integrated into the seat cushion 108 by, for example, positioning the under-seat airbag 130 in a cavity formed in the seat cushion 108.

A gas hose 124 operably connects the under-seat airbag 130 in fluid communication with an inflator (not shown in FIG. 1) positioned under the seat 102 or otherwise proximate the seat 102. In other embodiments, the inflator can be positioned within the under-seat airbag 130 and the gas hose 124 can be omitted. In some embodiments, a first electrical link, e.g., a first wire 126a, and a second electric link, e.g., a second wire 126b, can be routed to a seatbelt switch (not shown) that completes a circuit or is otherwise operable to indicate when the connector tongue on the second web portion 112b of the seatbelt 118 is properly coupled to the buckle 116, which can be a precondition for deployment of the under-seat airbag 130. As described in greater detail below, in response to, for example, a rapid deceleration of the aircraft or other accident scenario, the inflator can provide high pressure gas to the under-seat airbag 130, which inflates the airbag 130 and ruptures one or more tear seams on the cover 134 as the airbag 130 expands upwardly.

In some embodiments, the restraint systems described herein can be used to protect occupants in a wide variety of vehicles, including other types of aircraft (e.g., both fixed-and-rotary-wing aircraft), land vehicles (e.g., automobiles), watercraft, etc., and with a wide variety of seating arrangements and orientations, such as center aisle seats, outer aisle seats, seats positioned directly behind other seats, monuments, walls, partitions, consoles, closets, etc., “infinite setback seats” (seats that are not positioned behind other structures), and seats in other orientations relative to, for example, the forward end of the aircraft and/or the direction F of forward travel, such as side facing seats or seats orientated at other angles relative to the longitudinal axis A of the aircraft.

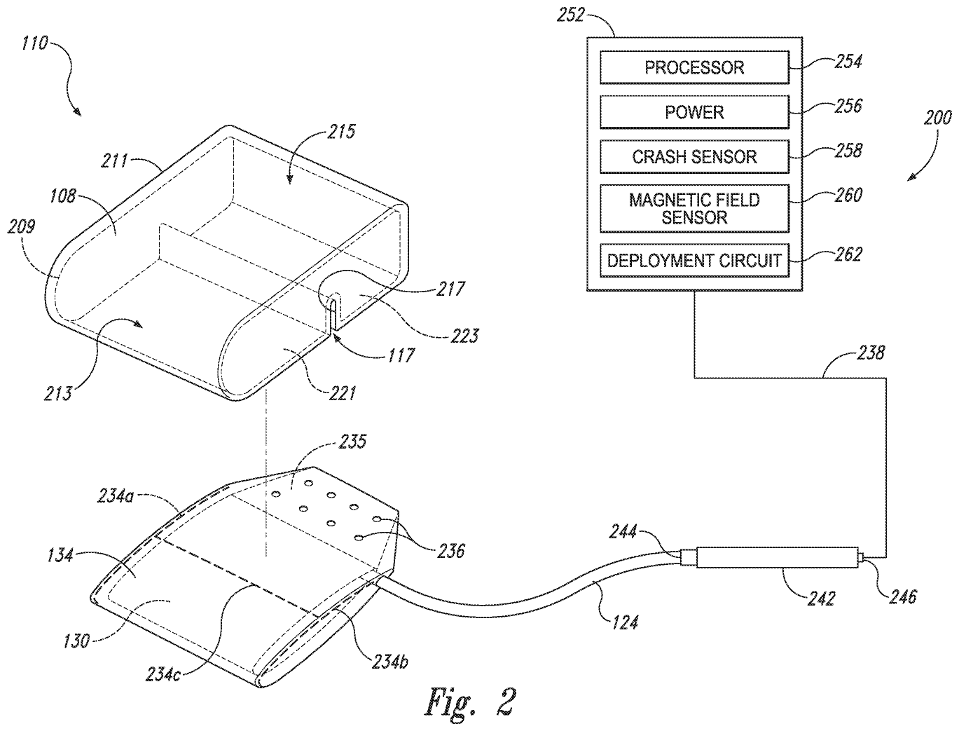

FIG. 2 is a partially schematic isometric view of some elements of the occupant restraint system 110 and an associated airbag deployment system 200 configured in accordance with embodiments of the present technology. The occupant restraint system 110 includes the seat cushion 108, which can include a compressible inner portion 209 and a cover 211. The cover 211 can fully or at least partially encase the compressible inner portion 209. The compressible inner portion 209 can be made of one or more conventional seat cushion material(s), such as a polyurethane foam or other suitable materials, either in a single layer or in layers of different or the same material(s). The cover 211 can also be made of conventional seat cover materials, such as cloth, nylon, vinyl, leather, or other suitable materials. The seat cushion 108 can also incorporate a fire-resistant material, such as Kevlar® or Nomex®, either as part of the cover 211 or as a separate layer surrounding the compressible inner portion 209 and/or the seat cushion 108.

The separation feature 117 extends at least partially through the seat cushion 108 to define a front cushion portion 213 and a rear cushion portion 215. For example, in some embodiments the separation feature 117 can be or include a slit, a gap, a tear seam, or other suitable separation feature or mechanism that enables the front cushion portion 213 to move upwardly more than the rear cushion portion 215 in response to, for example, inflation of the under-seat airbag 130. The separation feature 117 can be formed during the manufacturing process of the seat cushion 108 such that the compressible inner portion 209, including the portion of the compressible inner portion 209 adjacent the separation feature 117, is covered by the fire-resistant material. For example, even though the separation feature 117 extends through both the compressible inner portion 209 and the cover 211 in the illustrated embodiment, the cover 211 includes a preformed recess 217 that generally follows the shape of the separation feature 117 and therefore the cover 211 fully encases the compressible inner portion 209. In such embodiments, the fire-resistant material can be incorporated into the cover and/or be a layer that has generally the same shape as the cover 211. In other embodiments, the separation feature 117 can extend at least partially through the compressible inner portion 209 but does not extend through the cover 211 (e.g., the preformed recess 217 is omitted and the cover 211 and/or the fire resistant material can encase the compressible inner portion 209 in a conventional manner). In such embodiments, the separation feature 117 divides the compressible inner portion 209 into a front inner portion 221 and a rear inner portion 223. In yet other embodiments, the separation feature 117 can be formed by cutting a slit or other separation feature into a conventional seat cushion.

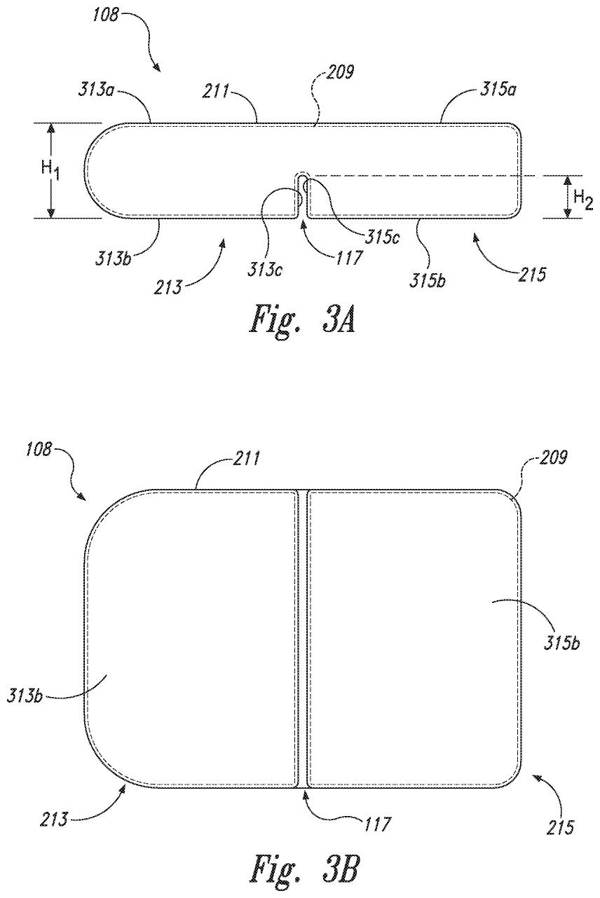

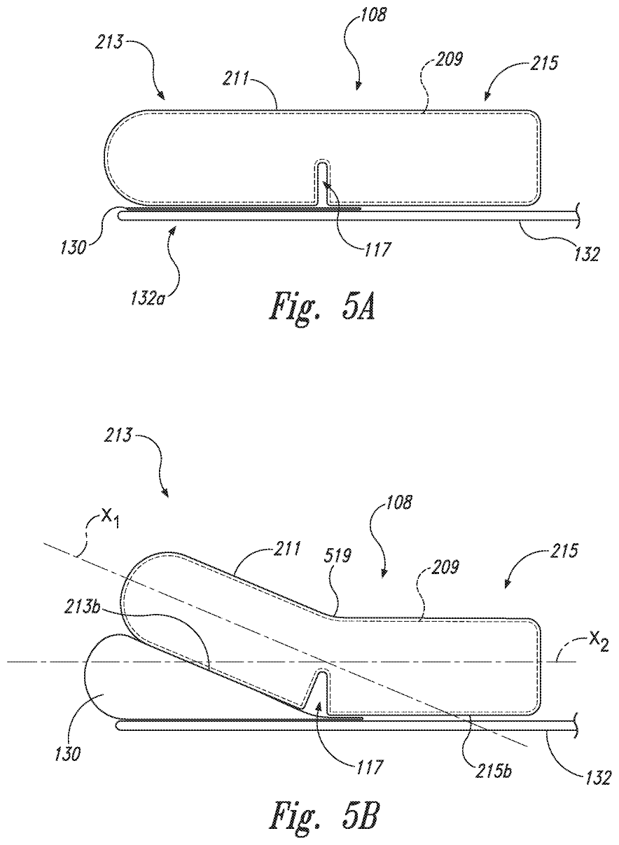

FIGS. 3A and 3B are side and bottom views, respectively, of the seat cushion 108 configured in accordance with embodiments of the present technology. Referring to FIG. 3A, the front cushion portion 213 can include a front upper surface portion 313a and a front lower surface portion 313b. Likewise, the rear cushion portion 215 can include a rear upper surface portion 315a and a rear lower surface portion 315b. The upper surface portions 313a, 315a are configured to contact, or at least generally face, a seat occupant. The lower surface portions 313b, 315b are configured to contact, or at least generally face, the seat pan 132 (FIGS. 5A and 5B). In the illustrated embodiment, the front lower surface portion 313b is separated from the rear lower surface portion 315b by the separation feature 117.

As noted above, the front cushion portion 213 and the rear cushion portion 215 are at least partially separated and/or separable by the separation feature 117 that extends generally transverse to the seat pan 132. The separation feature 117 can be or include a slit, a gap, a tear seam, or other suitable feature that, upon inflation of the under-seat airbag 130 (FIG. 2), enables the front cushion portion 213 to move upwardly and away from the seat pan a greater distance than the rear cushion portion 215. Although the separation feature 117 is shown as a physical gap between a rear surface portion 313c of the front cushion portion 213 and a front surface portion 315c of the rear cushion portion 215, in some embodiments the rear surface portion 313c and the front surface portion 315c may nevertheless touch or otherwise be engaged (e.g., embodiments in which the separation feature 117 is a slit, a tear seam, etc.).

In some embodiments in which the separation feature 117 is a separable feature configured to rupture or otherwise separate upon inflation of the under-seat airbag 130, the rear surface portion 313c and the front surface portion 315c can be at least partially connected until the under-seat airbag 130 (FIG. 5B) is inflated. For example, the rear surface portion 313c and the front surface portion 315c can comprise Velcro or other suitable material that can temporarily and releasably secure the rear surface portion 313c to the front surface portion 315c (e.g., before the airbag 130 is inflated). When the airbag 130 is inflated, however, the airbag 130 can generate an upward force on the front cushion portion 213 that causes the rear surface portion 313c to disengage and/or separate from the front surface portion 315c along the separation feature 117, permitting the front cushion portion 213 to move upwardly relative to the rear cushion portion 215.

In some embodiments, the front lower surface portion 313b can be connected to, or at least touch, the rear lower surface portion 315b at the separation feature 117 before the under-seat airbag 130 is inflated. For example, the front lower surface portion 313b can be connected to the rear lower surface portion 315b along a tear seam in the cover 211. In such embodiments, the compressible inner portion 209 can also include a slit or gap that separates or at least partially separates the front inner portion 221 and the rear inner portion 223. The tear seam can be configured to rupture upon inflation of the airbag 130 such that the front cushion portion 213 moves upwardly relative to the rear cushion portion 215 along the slit in the compressible inner portion 209.

In the illustrated embodiment, the seat cushion 108 has a height H₁ extending between the lower surface portions 313b, 315b and the upper surface portions 313a, 315a. The separation feature 117 has a height H₂ extending generally upward from the lower surface portions 313b, 315b. In some embodiments, the height H₂ is about half of the height H₁. In other embodiments, the height H₂ is greater than about half of the height H₁ or less than about half of the height H₁. For example, in some embodiments, the separation feature 117 extends through the entire height H₁ of the seat cushion 108 such that the front cushion portion 213 and the rear cushion portion 215 are not connected and/or are fully separable upon inflation of the airbag 130 (e.g., dividing the seat cushion 108 into two unconnected portions). In other embodiments, the separation feature 117 extends through the full height of the compressible inner portion 209 but not through the cover 211. In such embodiments, the front inner portion 221 and the rear inner portion 223 (FIG. 2) are not connected and/or are fully separable upon inflation of the airbag 130 (e.g., dividing the compressible inner portion 209 into two unconnected portions). As described above, in such embodiments the cover 211 may optionally include a tear seam connecting the front lower surface portion 313b and the rear lower surface portion 315b.

Referring to FIG. 3B, in the illustrated embodiment the separation feature 117 extends through the entire width of the seat cushion 108. For example, in embodiments in which the separation feature 117 is a slit or gap, the separation feature 117 can completely separate the front lower surface portion 313b and the rear lower surface portion 315b (e.g., the front lower surface portion 313b and the rear lower surface portion 315b are not connected). However, in embodiments in which the separation feature 117 does not extend upwardly for the full height H₁ of the seat cushion 108, the front upper surface portion 313a and the rear upper surface portion 315a remain connected (e.g., the front upper surface portion 313a and the rear upper surface portion 315a are integral), even after inflation of the under-seat airbag 130. As described in detail below with reference to 5A and 5B, the seat cushion 108 is configured such that, upon deployment of the under-seat airbag 130, the front cushion portion 213 moves upwardly and away from the seat pan 132 (FIG. 1) a greater distance than the rear cushion portion 215 moves away from the seat pan 132.

Returning to FIG. 2, the under-seat airbag 130 can be enclosed in the flexible and protective cover 134. The cover 134 can include one or more seams (e.g., tear seams) attached with stitching (e.g., “rip stitching”) that ruptures as the airbag 130 inflates so that the cover 134 falls away as the under-seat airbag 130 rapidly expands. For example, the cover 134 can include a first side tear seam 234a and a second side tear seam 234b. Additionally, in some embodiments the cover can also include a lateral tear seam 234c extending between the two side tear seams 234a, b. In addition to the tear seams 234a-c, the cover 134 can additionally include one or more holes 236 that extend through the cover 134 and an adjacent attachment panel 235 of the airbag 130, The holes 236 are configured to receive one or more fasteners (e.g., rivets, screws, adhesive, etc.; not shown in FIG. 2) that attach the airbag 130 and the cover 134 to the seat pan 132 (FIG. 1).

In some embodiments, the airbag deployment system 200 includes an electronic assembly 252 (e.g., an electronic module assembly (EMA); shown schematically) and an inflator 242. The electronic assembly 252 and/or the inflator 242 can be located, for example, under the seat 102 (FIG. 1), under an adjacent seat, or in other locations suitable for connectivity to the under-seat airbag 130. Various types of inflators known in the art can be used with the airbag systems described herein. In some embodiments, for example, the inflator 242 can include a stored gas canister that contains compressed gas (e.g., compressed air, nitrogen, argon, helium, etc.) at high pressure. The inflator 242 can include an initiator 246 (e.g., a pyrotechnic device such as a squib) operably positioned at one end and an outlet fitting 244 at the opposite end that connects the gas hose 124 to the inflator 242. In other embodiments, other suitable inflation devices well known in the art can be used without departing from the present disclosure. Such devices can include, for example, gas generator devices that generate high pressure gas through a rapid chemical reaction of an energetic propellant, hybrid inflators, etc. In some embodiments, the under-seat airbag 130 can include an inflator positioned within the airbag 130. Accordingly, the present disclosure is not limited to any particular type of airbag inflation device and/or system.

The electronic assembly 252 can be electrically connected to the inflator initiator 246 via one or more electrical links 238 (e.g., one or more wires). As discussed above, in some embodiments the occupant restraint system 110 can include a seatbelt switch (not shown) carried on a web connector (not shown) which is configured to change status (e.g., close a circuit or open a circuit) when the web connector is suitably engaged with the buckle 116. The connector status as determined by the switch can be transmitted to the electronic assembly 252 via the wires 126a, b to ensure that the under-seat airbag 130 is only deployed when the two web portions 112a, b of the seatbelt 118 are properly joined together, as this can prevent the under-seat airbag 130 from inadvertently inflating when the seatbelt 118 is not secured around the waist of a seat occupant.

In the illustrated embodiment, the electronic assembly 252 includes a processor 254 that receives electrical power from a power source 256 (e.g., one or more batteries, such as lithium batteries), a deployment circuit 262 that initiates the inflator 242, and at least one crash sensor 258 (e.g., an accelerometer) that detects rapid decelerations and/or other dynamic events greater than a preset or predetermined magnitude (e.g., a deceleration greater than 15 g's). The processor 254 can include, for example, suitable processing devices for executing non-transitory instructions stored on a computer-readable medium. The crash sensor 258 can, for example, include a spring-mass damper type sensor with an inertial switch calibrated for the vehicles operating environments that initiates airbag deployment upon a predetermined level of deceleration. In other embodiments, the crash sensor 258 can include other types of sensors known in the art and/or other additional features to facilitate airbag deployment. In further embodiments, some of the components of the electronic assembly 252 described above may be omitted and/or other components may be included. Although specific circuitry is described above, those or ordinary skill in the art will recognize that a microprocessor-based system could also be used where any logical decisions are configured in software.

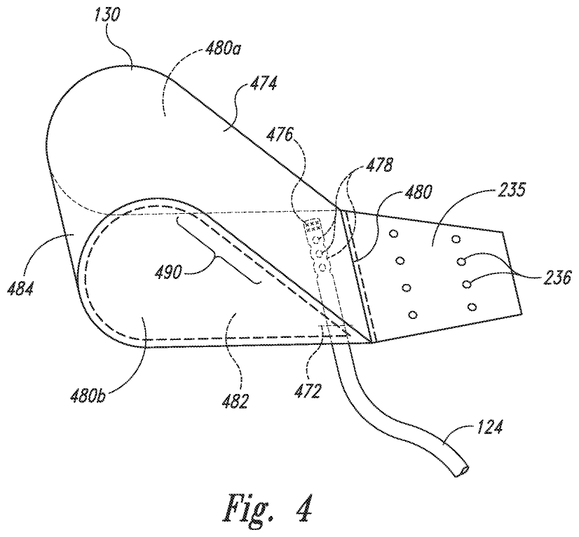

In a dynamic event above a predetermined threshold (e.g., a rapid deceleration equal to or greater than a predetermined magnitude resulting from the aircraft experiencing a collision or other significant dynamic event), the crash sensor 258 can detect the event and respond by sending a corresponding signal to the processor 254 that causes the processor 254 to send a corresponding signal to the deployment circuit 262. Upon receiving the signal and confirmation that the web connector is engaged with the buckle 116, the deployment circuit 262 applies a voltage to the inflator initiator 246 via the electrical link 238 sufficient to activate the initiator 246, which in turn opens or otherwise causes the inflator 242 to rapidly discharge its compressed gas into the under-seat airbag 130 via the gas hose 124. The rapid expansion of the compressed gas flowing into the under-seat airbag 130 causes the airbag 130 to rapidly expand and rupture or otherwise separate the tear seams 234a-c, causing the cover 134 to quickly move away from the airbag 130 so that the airbag 130 can rapidly inflate to full deployment in, for example, about 40 ms to 55 ms. Additional details regarding deployment of the under-seat airbag 130 are provided below with reference to FIGS. 4-7B.

The airbag deployment systems described above and elsewhere herein are provided by way of examples of suitable such systems. It should be noted, however, that the various embodiments of the airbags described herein are not limited to use with the particular inflation and/or other systems described above and can also be used with other types of inflation systems without departing from the present disclosure.

FIG. 4 is an isometric top view of the under-seat airbag 130 in the inflated state, configured in accordance with embodiments of the present technology. In some embodiments, the under-seat airbag 130 includes an upper or top panel 474, a bottom panel 482, a front panel 484, and first and second side panels 480a and 480b, respectively. In the illustrated embodiment, the top and bottom panels 474 and 482, respectively, can be generally flat and define an acute angle therebetween (e.g., an angle of from about 10 degrees to about 60 degrees, or from about 15 degrees to about 50 degrees, or about 45 degrees). Additionally, the front panel 484 can be at least generally rounded as it transitions from the bottom panel 482 to the top panel 474. As described in greater detail below, the foregoing configuration can give the under-seat airbag 130 a generally tapered or triangular profile shape that, in conjunction with the separation feature 117, causes the front cushion portion 213 to rise more than the rear cushion portion 215 during airbag inflation.

In the illustrated embodiment, the bottom panel 482 includes an opening 472 (e.g., a slit) that enables the gas hose 124 to extend into the interior volume of the under-seat airbag 130. A distal end portion of the gas hose 124 can be fixedly attached to the bottom panel 482 by stitching 476 or other suitable fastening means known in the art. Additionally, the distal end portion of the gas hose 124 includes a plurality of apertures or openings 478 that enable the high-pressure gas from the inflator 242 (FIG. 2) to rapidly flow into the under-seat airbag 130 for inflation thereof.

The under-seat airbag 130 can further include the attachment panel 235 that extends rearwardly from a seam 488 that joins the aft edge portion of the top panel 474 to the aft edge portion of the bottom panel 482. The attachment panel 235 can be composed of one or more layers of airbag material that are not inflated during airbag deployment. Rather, the attachment panel 235 can include a plurality of the holes 236 described above with reference to FIG. 2 that receive fasteners or other means for attaching the under-seat airbag 130 and its cover 134 (FIG. 2) to the seat pan 132 as described above with reference to FIG. 1.

In some embodiments, the under-seat airbag 130 includes one or more tear seams 490 that prevent the airbag 130 from fully inflating if the seat occupant is in a brace position. More specifically, the tear seam 490 can be a pressure sensitive seam that ruptures if the internal pressure within the airbag 130 prematurely exceeds a preset maximum as a result of the occupant's upper torso being positioned on or just above the occupant's thighs, as would be the case if the occupant was in the brace position. Preventing the under-seat airbag 130 from fully inflating when the occupant is in the brace position reduces the ability of the airbag 130 to push the occupant upwardly and out of the brace position (which is a relatively safe position in a crash event). Additionally, the tear seam 490 can also rupture once the under-seat airbag 130 fully inflates so that the airbag 130 quickly deflates and does not impede occupant egress away from the seating area. In other embodiments, the airbag 130 can include one or more vents, such as one or more vent holes, that enable the airbag 130 to quickly deflate after inflation.

The under-seat airbag 130 can be manufactured using various types of suitable airbag materials and construction techniques known to those of ordinary skill in the art. For example, in some embodiments the under-seat airbag 130 can be constructed by sewing together a plurality of flat panels or sheets of suitable material, such as silicone coated nylon fabric (e.g., 315 denier silicone coated woven nylon fabric), with a suitable thread using known techniques. In other embodiments, air bags configured in accordance with the present disclosure can be constructed using other suitable materials and construction techniques known in the art.

The airbag deployment, inflation and/or vent systems described above and elsewhere herein are provided by way of example of suitable such systems. It should be noted, however, that the various embodiments of the airbags described herein are not limited to use with the particular inflation and/or other systems described above, but can also be used with other types of inflation and/or vent systems without departing from the present disclosure.

FIG. 5A is a side view illustrating the seat cushion 108 positioned on the seat pan 132 with the under-seat airbag 130 in an uninflated state positioned therebetween. The under-seat airbag 130 can be secured to the seat pan 132 or other suitable structure as described above. The inflatable portion of the under-seat airbag 130 is generally positioned on a front portion 132a of the seat pan 132 such that the inflatable portion is generally under the front cushion portion 213. In other embodiments, the under-seat airbag 130 can be positioned more toward the rear of the seat pan 132 such that it resides under at least a portion of the front cushion portion 213 and a portion of the rear cushion portion 215. In yet other embodiments, the under-seat airbag 130 can be incorporated into the seat cushion 108, such as between the front lower surface portion 313b of the cover 211 and the front inner portion 221 (FIG. 2). In other embodiments, the under-seat airbag 130 can be incorporated into the front inner portion 221 (e.g., within a cavity in the seat cushion 108).

FIG. 5B is a side view illustrating the under-seat airbag 130 in an inflated state. As the under-seat airbag 130 inflates and expands, it drives the front cushion portion 213 at least partially away from the rear cushion portion 215 at the separation feature 117. As a result, the seat cushion 108 rotates upward at a hinge region 519 that is generally above the separation feature 117. Accordingly, the separation feature 117 facilitates bending or flexing of the seat cushion 108 at the hinge region 519. As one skilled in the art will appreciate, the hinge region 519 does not require a traditional mechanical hinge, but rather describes the ability of the front cushion portion 213 to flex or rotate upwardly relative to the rear cushion portion 215 because of the separation feature 117 and the relative thinness of the seat cushion 108 at the hinge region 519. Accordingly, when the under-seat airbag 130 is inflated, the front cushion portion 213 will have a longitudinal axis X₁ that is not parallel to a longitudinal axis X₂ of the rear cushion portion 215. More specifically, the longitudinal axis X₁ may have a steeper slope than the longitudinal axis X₂. However, as one skilled in the art will appreciate, the longitudinal axes X₁ and X₂ are representative, and in many embodiments the front cushion portion 213 and/or the rear cushion portion 215 will not necessarily be aligned along linear longitudinal axes extending therethrough due to the flexible composition of the seat cushion 108.

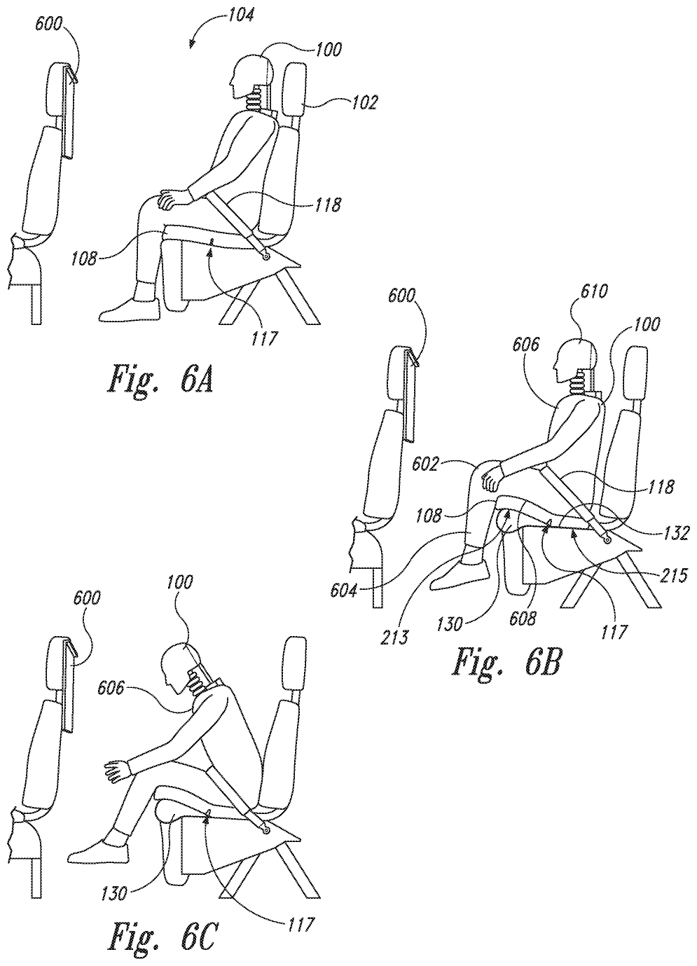

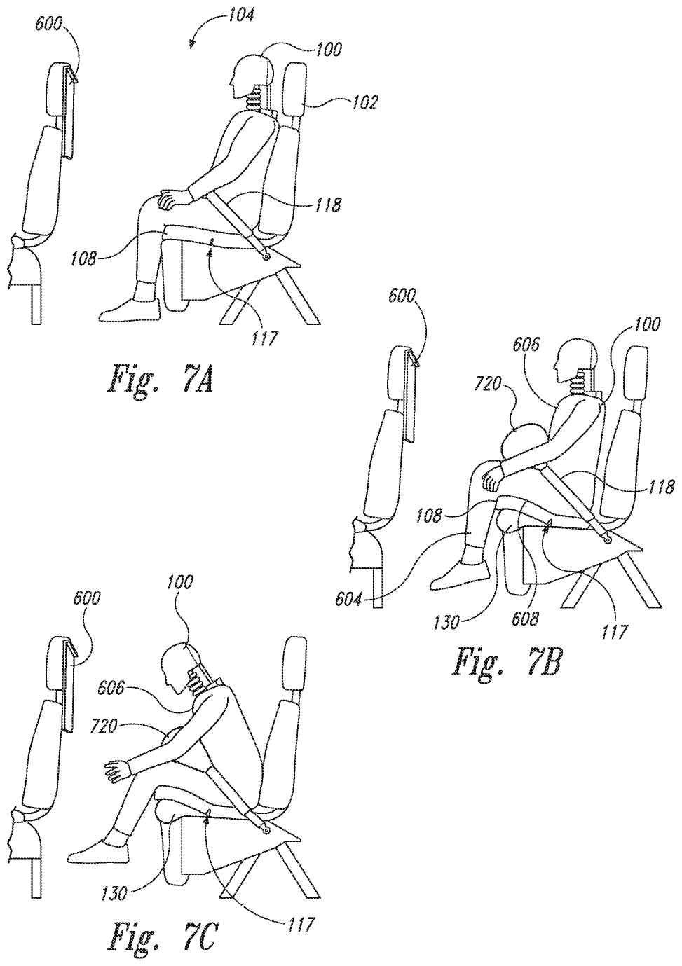

As described above, the under-seat airbag 130 can have a generally triangular or tapered shape when inflated such that a forward portion of the airbag 130 has a greater height than a rearward portion of the airbag 130. This shape causes under-seat airbag 130 to push the front cushion portion 213 upwardly and away from the seat pan 132 upon inflation, as shown in FIG. 5B. The separation feature 117 enables the front cushion portion 213 to be pushed upwardly while also reducing and/or preventing an accompanying upward force on the rear cushion portion 215. In some embodiments, the rear cushion portion 215 may be pushed at least slightly upwardly and away from the seat pan 132, although by a lesser distance or degree than the front cushion portion 213. In other embodiments, the rear cushion portion 215 is not pushed upwardly when the under-seat airbag 130 is inflated, as shown in FIG. 5B. Without being bound by theory, pushing the front cushion portion 213 upwardly from the seat pan 232 by a greater distance than the rear cushion portion 215 is expected to advantageously reduce the risk of injury for a seat occupant during an accident or similar dynamic event, as described below with reference to FIGS. 6A-7C.

FIGS. 6A-6C are a series of side views illustrating various stages of deployment of the under-seat airbag 130 in accordance with embodiments of the present technology. Referring first to FIG. 6A, this Figure illustrates a pre-deployment stage in which the occupant 100 is seated in the seat 102 in the seating area 104 with the lap seatbelt 118 properly secured around the occupant's waist. In FIG. 6A, the seat 102 is a forward-facing seat positioned behind a strike hazard 600. The strike hazard 600 can be virtually any type of structure typically found in front of a passenger seat or other seat (e.g., a pilot seat, flight attendant seat, etc.) on an aircraft, and can include, for example, the seatback of the seat positioned directly in front of the seat 102, a closet or galley wall or partition, a monument, etc. Although the seat 102 is illustrated as a forward-facing seat, in other embodiments the seat 102 can be an oblique facing seat as described above.

FIG. 6B illustrates the seating area 104 at the initial stage of a crash or other rapid deceleration event above a preset magnitude. The rapid deceleration event causes the occupant's torso 606 to begin moving forward about the seatbelt 118. The event also causes the airbag deployment system 200 described in detail above with reference to FIG. 2 to initiate rapid inflation of the under-seat airbag 130. As the under-seat airbag 130 inflates, it causes the front cushion portion 213 to rotate or otherwise move upwardly relative to the rear cushion portion 215 about the separation feature 117, thereby pushing upwardly on the occupant's thighs 608 just behind the occupant's knees 602. This drives the occupant's legs 604 upwardly toward the occupant's torso 606. Because of the separation feature 117, the rear cushion portion 215 either does not move upwardly or moves upwardly less than the front cushion portion 213. This reduces the tendency of the occupant's pelvic region 612 to move substantially upward with the occupant's legs 604. The upward momentum of the legs 604 relative to the pelvic region 612 reduces the forward rotation of the torso 606 and the overall forward excursion of the occupant's head 610 toward the strike hazard 600. Additionally, lifting the occupant's legs 604 in this manner reduces the tendency of the occupant 100 to translate forward on the seat pan 132, which further leads to a reduction in forward head excursion.

FIG. 6C illustrates the occupant 100 at a state of maximum or near maximum forward head excursion. As this view illustrates, the under-seat airbag 130 in combination with the seat cushion 108 having the separation feature 117 can significantly reduce forward head excursion toward the strike hazard 600. Additionally, it is expected that reduction of the forward head excursion in the forgoing manner can also reduce lumbar loads and potential injuries to the occupant 100.

One advantage of reducing occupant head excursion with the occupant restraint systems described above is that it enables airlines to place seats closer to potential head strike hazards, while still maintaining enough distance to the head strike hazard to avoid potentially injurious contact by the occupant in the event of a crash or other rapid deceleration event. Another benefit of embodiments of the present technology is that by concealing the under-seat airbag 130 beneath the seat cushion 108 and/or integrating the airbag 130 into the seat cushion 108, the airbag does not affect the cosmetics of the seating area 104. Additionally, by positioning the under-seat airbag 130 beneath the seat cushion 108 or a portion thereof, it does not adversely affect the comfort of the seat 102 for the occupant 100.

FIGS. 7A-7C are a series of side views illustrating various stages of deployment of the under-seat airbag 130 used in conjunction with a seatbelt airbag 720 in accordance with embodiments of the present technology. The seatbelt airbag 720 can be stowed within and deployable from the seatbelt 118. The seatbelt airbag 720 can be operably coupled to the airbag deployment system 200 (FIG. 2) such that both the seatbelt airbag 720 and the under-seat airbag 130 are both inflated in response to a dynamic event. As illustrated in FIG. 7B, the seatbelt airbag 120 inflates and expands between the occupant's torso 606 and the occupant's thighs 608 as the occupant 100 continues to rotate forward about the seatbelt 118. As the occupant's legs 604 move upwardly in response to inflation of the under-seat airbag 130 under the seat cushion 108 as described above, the momentum of the legs 604 is reacted by the occupant's torso 606 through the seatbelt airbag 120. This can further reduce forward head excursion toward the strike hazard 600 and/or reduce lumbar loads and potential injuries to the occupant 100. Additional features of the seatbelt airbag 720 are described in U.S. patent application Ser. No. 16/351,140, titled “AIRBAG SYSTEMS FOR USE ON AIRCRAFT,” and other patents and applications referenced herein, the disclosures of which are incorporated herein by reference in their entireties.

Various airbag systems and associated components are described in U.S. Pat. Nos. 5,984,350; 6,439,600; 6,505,854; 6,505,890; 6,535,115; 6,217,066; 6,957,828; 7,665,761; 7,980,590; 8,403,361; 8,439,398; 8,469,397; 8,523,220; 8,556,293; 8,818,759; 8,914,188; 9,156,558; 9,176,202; 9,153,080, 9,352,839; 9,511,866; 9,889,937; 9,925,950; 9,944,245; and 10,391,960; in U.S. Patent Publication Nos.: 2012/0326422; 2016/0052636; 2018/0201375; 2019/0315470; in U.S. patent application Ser. Nos. 16/292,222; 16/351,140; 16/358,354; and Ser. No. 16/453,210; and in U.S. Provisional Patent Application No. 62/495,602, each of which is incorporated herein by reference in its entirety. Indeed, any patents, patent applications and other references identified herein are incorporated herein by reference in the entirety, except for any subject matter disclaimers or disavowals, and except to the extent that the incorporated material is inconsistent with the express disclosure herein, in which case the language in this disclosure controls, Aspects of the invention can be modified, if necessary, to employ the systems, functions, and concepts of the various references described above to provide yet further implementations of the invention.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the disclosure. The upper and lower limits of these smaller ranges may independently be included or excluded in the range, and each range where either, neither or both limits are included in the smaller ranges is also encompassed within the disclosure, subject to any specifically excluded limit in the stated range. Where the stated range includes one or both of the limits, ranges excluding either or both of those included limits are also included in the disclosure.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application,

I/We claim:

1. A system for use with a seat on an aircraft, the system comprising:
a seat cushion configured to be positioned on a seat pan, wherein the seat cushion includes:
a front cushion portion positionable adjacent a front portion of the seat pan,
a rear cushion portion positionable adjacent a rear portion of the seat pan, and
a separation feature configured to extend transverse to the seat pan, wherein the front cushion portion is at least partially separated or separable from the rear cushion portion along the separation feature; and
an airbag configured to be operably positioned between the seat pan and the seat cushion, wherein the airbag is further configured to inflate in response to a dynamic event and move the front cushion portion upwardly and away from the seat pan a greater distance than the rear cushion portion moves away from the seat pan.

2. The system of claim 1 wherein the separation feature comprises a slit in the seat cushion, and wherein the front cushion portion is at least partially separated from the rear cushion portion at the slit.

3. The system of claim 2 wherein the seat cushion includes an upper surface and a lower surface, and wherein the slit extends upwardly from the lower surface.

4. The system of claim 2 wherein the seat cushion has a first height and the slit has a second height that is about half of the first height.

5. The system of claim 2 wherein the seat cushion has a first height and the slit has a second height that is greater than half of the first height.

6. The system of claim 2 wherein the seat cushion has a first height and the slit has a second height that is less than half of the first height.

7. The system of claim 1 wherein the seat cushion has a width, and wherein the separation feature extends the entire width of the seat cushion.

8. The system of claim 1 wherein the front cushion portion is hingedly attached to the rear cushion portion at or adjacent the separation feature.

9. The system of claim 1 wherein the front cushion portion is disconnected from the rear cushion portion at the separation feature.

10. The system of claim 1 wherein the seat cushion includes a compressible inner portion and a cover, and wherein the separation feature extends through both the compressible inner portion and the cover.

11. A system for use with a seat on an aircraft, the system comprising:
a seat cushion configured to be positioned on a seat pan, wherein the seat cushion includes:
a compressible inner portion including (i) a front cushion portion positionable adjacent a front portion of the seat pan, and (ii) a rear cushion portion positionable adjacent a rear portion of the seat pan and at least partially separated or separable from the front cushion portion, and
a cover at least partially encasing the compressible inner portion;
an airbag configured to be operably positioned to inflate between the seat pan and the seat cushion,
wherein inflation of the airbag drives the front cushion portion upwardly and further away from the seat pan than the rear cushion portion.

12. The system of claim 11 wherein the front cushion portion is at least partially separated from the rear cushion portion by a gap extending through the compressible inner portion.

13. The system of claim 11 wherein the front cushion portion is at least partially separated from the rear cushion portion by a gap extending through the compressible inner portion and the cover.

14. The system of claim 11 wherein the airbag is positioned between the compressible inner portion and the cover.

15. The system of claim 11 wherein the airbag is at least partially incorporated into the front cushion portion.

16. The system of claim 1 wherein the seat cushion is configured to raise a seat occupant's thighs by a greater distance than the seat occupant's pelvic region upon inflation of the airbag.

17. A seat cushion for use with an under-seat airbag on an aircraft, the seat cushion comprising:
a front cushion portion positionable adjacent a front portion of the seat pan, wherein the front cushion portion has an upper surface and a lower surface;
a rear cushion portion positionable adjacent a rear portion of the seat pan, wherein the rear cushion portion has an upper surface and a lower surface; and
a separation feature extending laterally through the seat cushion, wherein the front cushion portion lower surface is separated or separable from the rear cushion portion lower surface at the separation feature.

18. The seat cushion of claim 17 wherein the front cushion portion upper surface is integral with the rear cushion portion upper surface.

19. The seat cushion of claim 17 wherein the seat cushion is configured to bend or otherwise hinge at and/or adjacent to the separation feature.

20. The seat cushion of claim 19 wherein a distance between the front cushion portion lower surface and the rear cushion portion lower surface is configured to increase when the seat cushion bends or otherwise hinges at the separation feature.
